(19) United States
(12) Patent Application Publication
(10) Pub. No.: US 2004/0125559 A1
(43) Pub. Date: Jul. 1, 2004

(54) Computer with cooling device

(75) Inventor: Andreas Reineke, Paderborn (DE)

Correspondence Address: Mark Kusner Co., LPA, Highland Place - Suite 310, 6151 Wilson Mills Road, Highland Heights, OH, 44143, US

(73) Assignee: Medion AG

(21) Appl. No.: 10/701,055

(22) Filed: Nov. 4, 2003

(30) Foreign Application Priority Data
Nov. 5, 2002 (DE) 102 51 540.9

(51) Int. Cl. G06F 1/20

(52) U.S. Cl. 361/687; 361/709; 165/104.33

(57) ABSTRACT

The invention relates to a computer with a case in which at least one cooling device and at least one electrical component to be cooled are arranged. The case has at least one ventilation opening wherein this is arranged on the side of the case opposite to the electrical component. The cooling device is arranged between the ventilation opening and the component such that a substantially rectilinear air flow onto the component is formed inside the case.

The invention relates to a computer with a case in which at least one cooling device and at least one electrical component to be cooled are arranged.

Computers of the aforesaid type are generally known. These are generally supplied with a cooling device in order to cool the electrical components located inside the case such as the CPU (central processing unit). In addition to the CPU, for example, the graphics card and the power supply also benefit from active cooling. Depending on the requirements, it can also be logical to cool the hard disks or even the drives.

It is known that a CPU of a computer generates a large heat flow during operation. With the progress of technological development it can furthermore be recognised that the operating speed of a CPU has increased continuously which has the consequence that the heat flow generated by a CPU during operation has also increased. This means that present-day CPUs are generating an increasing amount of heat. Inadequate cooling results in malfunctioning of the computer. Known cooling devices do not solve the problem satisfactorily.

In order to convey a sufficiently large air flow from the surroundings into the computer, it is known that the case has openings at its rear wall. During operation of the cooling device cooler ambient air flows into the interior of the case through the openings in the rear wall. However, the air flow inside the computer is non-directional since as a result of the various components inside the case, a plurality of air vortices are formed. This has the result that the cooler ambient air mixes with the warmer air inside the case. The temperature of the air flow conveyed by a fan located in the cooling device onto the CPU affixed to the side wall is thus considerably higher than the actual temperature of the ambient air with which more effective cooling of the CPU would be attainable.

It is also known that a bend or a tunnel are used in order to use exclusively the cooler ambient air for cooling the CPU. In most cases, the bend is a flexible hose which runs from the rear wall of the case to the CPU affixed to the side wall. More efficient cooling of the CPU is thereby achieved. A disadvantage however is that the bend requires a large amount of space and expenditure on assembly.

The object of the invention is to further develop a computer with which the problems described can be avoided.

In order to solve this object a computer having the features of claim 1 is proposed.

The computer has a case in which at least one cooling device and at least one electrical component to be cooled are arranged. The case has at least one ventilation opening wherein this is arranged on the side of the case opposite to the electrical component. The cooling device is arranged between the ventilation opening and the component such that a substantially rectilinear air flow onto the component is formed inside the case. Direct air stream over a short path is thereby achieved from one side of the case to the opposite side where the component to be cooled, for example, a CPU is affixed.

As a result of the direct air circulation, the intaken ambient air is not substantially heated inside the computer case so that a good CPU cooling effect is achieved. Furthermore, a fan having a lower rotational speed can be used, which is at the same time associated with lower creation of noise.

Another advantage of the invention is that the ventilation openings are arranged on the side of the case opposite to the CPU. In contrast to this, in commercially available computer cases having two parallel side walls and a front and rear wall in addition to base and cover plates, ventilation openings are arranged on the rear wall. A disadvantage here is that the ambient air is sucked in by the ventilation openings arranged in the rear wall but the ambient air is not directed directly onto the CPU affixed to the side wall. The ambient air thus mixes first with the warmer air located in the case before it reaches the CPU. By using a ventilation opening on the opposite side wall of the CPU, substantially direct air circulation onto the CPU is achieved, that is said bends are dispensed with.

The present invention furthermore utilises the advantage of the shorter distance between the opposite side walls.

Consequently, the cooling capacity of the CPU can be increased by the subject matter according to the invention, which is especially important in summer. At ambient temperatures of 30° it becomes particularly hot in the narrow computer case, which means that temperatures of 40 to 50° are quite common.

As a result of the good cooling effect of the present invention, less powerful cooling devices can be used which for example have smaller dimensions and/or a lower power requirement. Noise and power costs can thereby be reduced.

In one development of the invention the area of the case having the ventilation opening is offset towards the opposite side of the case. In other words, the side wall of the case formed with the ventilation opening is arched into the interior of the computer. This brings about a further reduction in the distance from the opposite side wall on which the CPU is located.

According to one embodiment, horizontal axes of the cooling device, the component and the area of the case having the ventilation opening lie in one plane. Such an arrangement makes it possible to direct the drawn-in ambient air substantially rectilinearly onto the electrical component to be cooled.

The cases can be rectangular and for example, made of light metal. It is important for the invention that the cooling device is arranged between the case walls which are a short distance one from the other.

In addition to a CPU, other heat-generating components such as the hard disk, graphics card and so on can also be cooled as the component to be cooled.

The cooling device can comprise a fan and a heat sink. The heat sink consists of good heat-conducting materials and ensures that the heat generated by the CPU is transferred to the heat sink. The fan can be a normal “ventilator”. The air reaching the heat sink absorbs the heat of the heat sink as a result of the temperature gradient and cools the CPU. In order to provide a compact cooling device, it is possible to construct the fan and the heat sink or the CPU and the heat sink as a component.

A heat-conducting medium can be arranged between the heat sink and the component to be cooled, for example, a heat-conducting paste applied to the CPU. The heat-conducting paste can, for example, be silicone-based or comprises metals or their oxides. The latter have the advantage that they are better heat conductors than silicone paste.

Located next to one another in the space between opposite case walls are: the electrical component, if appropriate a cooling device, the fan. Any remaining space can be filled with a device along which the cooling air is transported. This device can be a pipe. The device/extension can also be a component of the fan or the cooling device.

The device can consist of a flexible material. In this case it is feasible to use a flexible spiral hose as the device.

The case can have further openings for air exchange.

A filter can be arranged along the air path for cooling the component.

In one embodiment the heat sink can be made of metal, especially of aluminium and copper.

The heat sink can be a passive cooling element for example in the form of cooling fins (ribs).

Further features of the invention are obtained from the features of the dependent claims and the other application documents.

The invention is explained in detail below with reference to an exemplary embodiment. In the figures

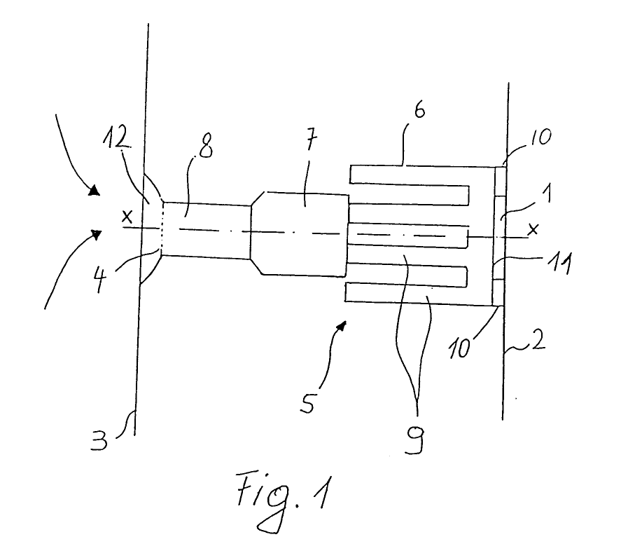

FIG. 1 shows a highly schematic diagram of an embodiment of the computer according to the invention.

FIG. 1 shows a longitudinal section through a computer case (housing). A left case wall 3 and a right case wall 2 can be identified. A CPU 1 is affixed to the case wall 2. Located on the surface of the CPU 1 is a cooling device 5, namely a heat sink 6 which absorbs and removes the heat from the CPU 1 as a result of its good heat-conducting material properties.

The heat sink 6 is constructed with fins 9 whereby the surface of the heat sink 6 is increased many-fold and thus the heat exchange can also be increased. The heat sink 6 is affixed to the side wall 2 with screws 10. In order to improve the heat conduction between the CPU 1 and the heat sink 6, a heat-conducting paste 11 is arranged between these components.

Located on the heat sink 6 is the fan 7 (ventilator) which sucks the cool ambient air into the interior of the computer and blows it in the direction of the heat sink 6 which absorbs the heat from the CPU 1. Located on the side wall 3 opposite the CPU 1 are ventilation openings 4 through which the ambient air flows into the case. The side wall 3 is offset towards the opposite side wall 2 in the area of the openings 4. As a result, a bead-shaped recess 12 is formed in the side wall 3. Between the side wall 3 constructed with ventilation openings 4 and the fan 7 there is a cylindrical pipe 8 through which the ambient air flows in the direction of the fan 7. The pipe 8 is in this case detachably connected to the fan 7 and the side wall 3.

In the present embodiment the ambient air flows substantially rectilinearly onto the CPU 1 (X-X axis) without mixing with the warmer air inside the case. In this case the cooler ambient air absorbs heat from the heat sink 6, whereby cooling of the CPU 1 is indirectly accomplished. The air laden with heat can, for example, be removed from the computer case through exhaust air openings not shown.

1. A computer comprising
a) a case in which at least
b) one cooling device (5) and
c) one electrical component (1) to be cooled are arranged, wherein
d) the case has at least one ventilation opening (4),
e) the ventilation opening (4) is arranged on a side of the case opposite to the electrical component (1),
f) the cooling device (5) is arranged between the ventilation opening (4) and the electrical component (1) so that a substantially rectilinear air flow onto the component (1) is formed inside the case.

2. The computer according to claim 1, wherein a region of the case having the ventilation opening (4) is offset towards an opposite side of the case.

3. The computer according to claim 1 wherein the horizontal axes of the cooling device (5), the component (1) and the region of the case having the ventilation opening (4) lie in one plane.

4. The computer according to claim 1, wherein the case is rectangular.

5. The computer according to claim 1, wherein the component (1) is a central data processing unit.

6. The computer according to claim 1, wherein the cooling device (5) comprises a fan (7) and a heat sink (6).

7. The computer according to claim 6, wherein the heat sink (6) abuts against the central data processing unit (1).

8. The computer according to claim 7, wherein a heat-conducting medium (11) is arranged between the heat sink (6) and the central data processing unit (1).

9. The computer according to claim 6, which has a device (8) which is arranged between the fan (7) and the ventilation opening (4).

10. The computer according to claim 6, which has a device (8) which is arranged between the heat sink (6) and the fan (7).

11. The computer according to claim 9 and claim 10, wherein the device (8) is cylindrical.

12. The computer according to claim 9 and claim 10, wherein the device (8) is made of flexible material.

13. The computer according to claim 1, wherein the case has a plurality of ventilation openings (4).

14. The computer according to claim 13, wherein the region of the case having the ventilation openings (4) is circular.

15. The computer according to claim 1, wherein the case has air outlet openings.

16. The computer according to claim 1, wherein a filter is arranged along the flow path of the air.

17. The computer according to claim 6, wherein the heat sink (6) is made of metal, especially of aluminum or copper.

18. The computer according to claim 6, wherein the heat sink (6) is constructed with fins (9).
